(19) United States
(12) Patent Application Publication
(10) Pub. No.: US 2023/0416526 A1
(43) Pub. Date: Dec. 28, 2023

(54) Polycarbonate Compositions Containing Titanium Dioxide and Epoxy Group-Containing Triacylglycerol

(71) Applicant: Covestro Deutschland AG, Leverkusen (DE)

(72) Inventors: Rolf Wehrmann, Krefeld (DE); Helmut Werner Heuer, Siegen (DE); Anke Boumans, Bedburg-Hau (DE)

(21) Appl. No.: 18/037,905

(22) PCT Filed: Nov. 18, 2021
(86) PCT No.: PCT/EP2021/082124

§ 371 Date: May 19, 2023

(30) Foreign Application Priority Data
Nov. 23, 2020 (EP) 20209236.7

(51) Int. Cl. C08L 69/00; C08K 3/22; C08K 5/50; C08K 5/42

(52) U.S. Cl. CPC C08L 69/005; C08K 3/22; C08K 5/50; C08K 5/42; C08K 2003/2241; C08L 2201/02; C08L 2203/206

(57) ABSTRACT

The present disclosure is direct to titanium dioxide-containing, polycarbonate-based thermoplastic compositions that contain epoxidized triacylglycerol. These compositions are suitable for reflectors. The compositions described in the present disclosure have an improved reflectance and a lower yellowness index as compared to reference compositions that do not contain epoxidized triacylglycerol. The epoxidized triacylglycerol may be in the form of epoxidized soybean oil.

### CROSS-REFERENCE TO RELATED APPLICATIONS

This application is the United States national phase of International Application No. PCT/EP2021/082124 filed Nov. 18, 2021, and claims priority to European Patent Application No. 20209236.7 filed Nov. 23, 2020, the disclosures of which are hereby incorporated by reference in their entireties.

### BACKGROUND OF THE INVENTION

### Field of the Invention

The present invention provides titanium dioxide-containing polycarbonate-based compositions having high reflectance and preferably good flame retardancy properties. The present invention further relates to molded parts composed of these compositions, for instance for housings/housing parts or other elements in the electricals and electronics and IT sectors, for example for trim pieces and switches for automotive interior illumination and in particular for reflectors of illumination units such as LED lamps or LED arrays.

### Description of Related Art

It is known from the prior art to add titanium dioxide to plastics such as polycarbonate to improve reflectance.

CN 109867941 A for instance describes a reflective polycarbonate material containing titanium dioxide, a liquid silicone and further polymeric constituents.

Furthermore, a multiplicity of flame retardants suitable for polycarbonate and preferably added to the plastics material for applications in the electricals and electronics and IT sectors are known.

TW 200743656 A discloses flame-retardant, halogen-free, reflective polycarbonate compositions which, in addition to titanium dioxide, contain inorganic fillers such as clay or silica and further organic components such as optical brighteners, perfluoroalkylene compounds and metal salts of aromatic sulfur compounds.

JP 2010138412 A describes flame-retardant titanium dioxide-containing polycarbonate compositions containing silicone compounds, PTFE and inorganic components such as talc, mica or glass.

For components such as reflectors for example there is a demand for compositions having ever higher reflectance to utilize the employed energy as well as possible.

However, large amounts of titanium dioxide are required to achieve high reflectance values. This is disadvantageous since titanium dioxide can lead to decomposition of the polycarbonate matrix, thus potentially leading to melt instabilities and a reduction in the viscosity of the compound, as a result of which thermal and mechanical properties are also impaired.

The amount of titanium dioxide also has a marked effect on the cost of the polycarbonate compositions and it is therefore desirable to increase reflectance through measures other than addition of ever greater amounts of titanium dioxide.

Optical brighteners that could be added in turn have the disadvantage that their use results in a nonlinear reflectance curve which can lead to a blue tint of the material which is considered disruptive.

Due to the use of many reflective components in the electricals and electronics sector, there is often a desire for sufficient flame retardancy. However, the addition of flame retardants typically has an adverse effect on a wide variety of properties.

### SUMMARY OF THE INVENTION

It is accordingly an object of the present invention to provide titanium dioxide-containing, polycarbonate-based compositions having improved reflectance and preferably a flame retardancy of UL94 V-0 at 2 mm wall thickness and corresponding molded parts, wherein in addition to achieving the recited properties the compositions preferably should not exhibit significantly poorer flow behavior during processing and should ideally also lack disruptive tints.

It has surprisingly been found that titanium dioxide-containing compositions based on polycarbonate exhibit elevated reflectance values when epoxidized triacylglycerol, especially in the form of epoxidized soybean oil, is present. At the same time a positive effect on yellowness index is generally also observable. The flow behavior of the compositions is not significantly affected and the good processability in injection molding is retained. Surprisingly, when using flame retardants the flame retardancy properties determined according to UL94 also remain virtually unchanged.

According to the invention preference is given to compositions exhibiting good reflectance, but also flame retardancy, properties.

### DETAILED DESCRIPTION

The present invention accordingly provides thermoplastic compositions containing
A) aromatic polycarbonate,
B) titanium dioxide,
C) epoxidized triacylglycerol, in particular incorporated into the composition in the form of epoxidized soybean oil.

Preferred compositions according to the invention are thermoplastic compositions, containing
A) 59.99% by weight to 96.99% by weight of aromatic polycarbonate,
B) 3.0% by weight to 40.0% by weight of titanium dioxide,
C) 0.01% by weight to 5.0% by weight of epoxidized triacylglycerol, in particular introduced into the composition in the form of epoxidized soybean oil,
wherein the reported amounts in % by weight are based on the total weight of the composition.

The compositions more preferably contain
A) 69.99% by weight to 96.99% by weight of aromatic polycarbonate,
B) 3.0% by weight to 30.0% by weight of titanium dioxide,
C) 0.01% by weight to 2.0% by weight of epoxidized triacylglycerol, in particular introduced into the composition in the form of epoxidized soybean oil.
D) 0.0% by weight to 1.0% by weight of heat stabilizer,
E) 0.0% by weight to 0.5% by weight of flame retardant selected from the group of alkali metal, alkaline earth metal or ammonium salts of aliphatic or aromatic sulfonic acid, sulfonamide or sulfonimide derivatives and combinations thereof and
F) 0.0% by weight to 10.0% by weight of further additives.

The compositions particularly preferably contain
A) 77.985% by weight to 96.985% by weight, preferably 77.945% by weight to 96.945% by weight, in particular 79.79% by weight to 89.79% by weight, of aromatic polycarbonate,
B) 3.0% by weight to 22% by weight, in particular 10% to 20% by weight, of titanium dioxide,
C) 0.01% to 0.8% by weight, preferably 0.05% by weight to 0.8% by weight, of epoxidized triacylglycerol, in particular introduced into the composition in the form of epoxidized soybean oil,
D) 0.005% by weight to 0.5% by weight, in particular 0.01% to 0.2% by weight, of heat stabilizer,
E) 0.0% by weight to 0.5% by weight, in particular 0.05% to 0.5% by weight, of flame retardant selected from the group of alkali metal, alkaline earth metal or ammonium salts of aliphatic or aromatic sulfonic acid, sulfonamide or sulfonimide derivatives and combinations thereof and
F) 0.0% by weight to 3% by weight, in particular 0.1% to 3% by weight, of further additives.

It is very particularly preferable when at least one alkali metal, alkaline earth metal or ammonium salt of an aliphatic or aromatic sulfonic acid, sulfonamide or sulfonimide derivative or a combination of two or more from this group is present in an amount of 0.05% to 0.5% by weight based on the total composition. It will be appreciated that the flame retardant of component E present may also be mixtures of the abovementioned compounds falling under the same umbrella term. It is especially preferable when at least potassium perfluoro-1-butanesulfonate is present.

In the context of the present invention—unless explicitly stated otherwise—the stated percentages by weight for components A, B, C—or C1—and optionally D and/or optionally E and/or optionally F are each based on the total weight of the composition. It will be appreciated that all of the components present in a composition according to the invention sum to 100% by weight. In addition to the components A, B and C, the composition may comprise further components, for instance further additives in the form of component F. The composition may also contain one or more further thermoplastics not covered by any of the components A to F as blend partners. It is very particularly preferable when the above-described compositions contain no further components but rather the amounts of the components A, B, C (or C1-epoxidized soybean oil containing epoxidized triacylglycerol or epoxidized triacylglycerol) and optionally D and/or optionally E and/or optionally F, in particular in the described preferred embodiments, sum to 100% by weight, i.e. the compositions consist of the component A, B, C (optionally C1), optionally D, optionally E and/or optionally F.

It will be appreciated that the employed components may contain typical impurities arising for example from their production process. It is preferable to use the purest possible components. It will further be appreciated that these impurities may also be present in the event of an exhaustive formulation of the composition.

The compositions according to the invention are preferably used for producing molded parts. The compositions preferably have a melt volume-flow rate (MVR) of 3 to 40 cm³/(10 min), more preferably of 6 to 30 cm³/(10 min), particularly preferably of 8 to 25 cm³/(10 min), very particularly preferably of 9 to 24 cm³/(10 min), determined in accordance with ISO 1133:2012-3 (test temperature 300° C., mass 1.2 kg).

Alternatively or preferably in addition the compositions according to the invention have a VO rating in the UL94 fire test (2.0 mm wall thickness).

The present invention also provides for improving the reflectance, preferably determined according to ASTM E 1331-2015 at a layer thickness of 2 mm, of titanium dioxide-containing polycarbonate compositions through addition of epoxidized triacylglycerol, in particular in the form of an epoxidized soybean oil. The improvement in reflectance is with reference to the corresponding compositions without epoxidized triacylglycerol, in particular in the form of an epoxidized soybean oil. An improvement in yellowness index is preferably also achieved, preferably determined according to ASTM E 313-15 (observer 10°/illuminant: D65) on sample sheets having a layer thickness of 2 mm. Here too, the reference is as described above. It will be appreciated that the features recited as preferred etc. for the composition also apply in respect of the use according to the invention.

The compositions whose reflectance is further improved through addition of component C have a reflectance before addition of component C of at least 93.5%, more preferably 95%, determined according to ASTM E 1331-2015 at a layer thickness 2 mm.

The individual constituents of the compositions according to the invention are more particularly elucidated hereinbelow:

Component A

For the purposes of the invention, the term “polycarbonate” is understood to mean both aromatic homopolycarbonates and aromatic copolycarbonates. These polycarbonates may be linear or branched in the familiar manner. According to the invention, it is also possible to use mixtures of polycarbonates.

Compositions according to the invention preferably contain as component A) 59.99% by weight to 96.99% by weight of aromatic polycarbonate. In accordance with the invention, a proportion of at least 59.99% by weight of aromatic polycarbonate in the overall composition means that the composition is based on aromatic polycarbonate. The amount of the aromatic polycarbonate in the composition is preferably 69.99% by weight to 96.99% by weight, more preferably 69.95% by weight to 96.985% by weight, in particular up to 96.95% by weight, yet more preferably 77.985% by weight to 96.985% by weight, particularly preferably 77.945% by weight to 96.945% by weight, very particularly preferably 79.79% by weight to 89.79% by weight, exceptionally preferably up to 89.7% by weight, wherein a single polycarbonate or a mixture of two or more polycarbonates may be present.

The polycarbonates present in the compositions are produced in a known manner from dihydroxyaryl compounds, carbonic acid derivatives, and optionally chain terminators and branching agents.

Details of the production of polycarbonates have been set out in many patent specifications over the past 40 years or so. Reference may be made here for example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and lastly to U. Grigo, K. Kirchner and P. R. Müller “Polycarbonate” [Polycarbonates] in Becker/Braun, Kunststoff-Handbuch [Plastics Handbook], Volume 3/1, Polycarbonate, Polyacetale, Polyester, Celluloseester [Polycarbonates, polyacetals, polyesters, cellulose esters], Carl Hanser Verlag Munich, Vienna 1992, pages 117 to 299.

Aromatic polycarbonates are produced, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Production via a melt polymerization process by reaction of dihydroxyaryl compounds with, for example, diphenyl carbonate is likewise possible.

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

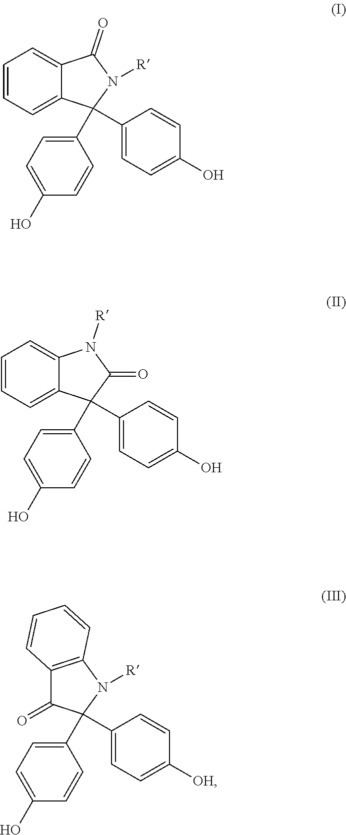

in which each R′ is C₁- to C₄-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,365 A, 2,999,825 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964” and also in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used.

Examples of suitable carbonic acid derivatives are phosgene or diphenyl carbonate.

Suitable chain terminators that may be employed in the production of the polycarbonates are monophenols. Examples of suitable monophenols include phenol itself, alkylphenols such as cresols, p-tert-butylphenol, cumylphenol, and also mixtures thereof.

Preferred chain terminators are phenols which are mono- or polysubstituted with linear or branched, preferably unsubstituted C₁- to C₃₀-alkyl radicals or with tert-butyl. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (I), (II) and (III)

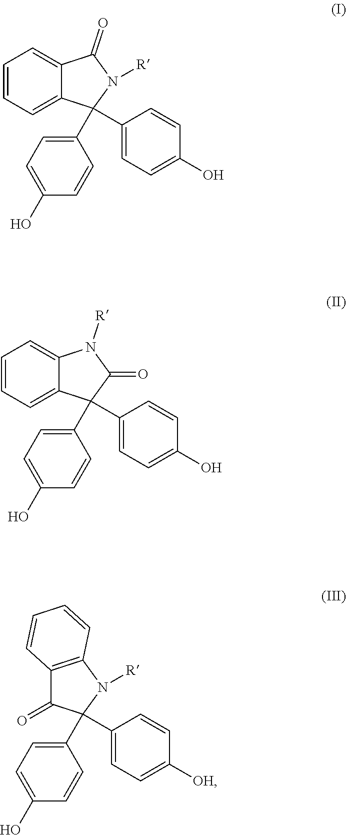

in which R′ in each case represents C₁- to C₄-alkyl, aralkyl or aryl, preferably methyl or phenyl, very particular preferably methyl.

Also preferred are copolycarbonates produced using diphenols of general formula (1a):

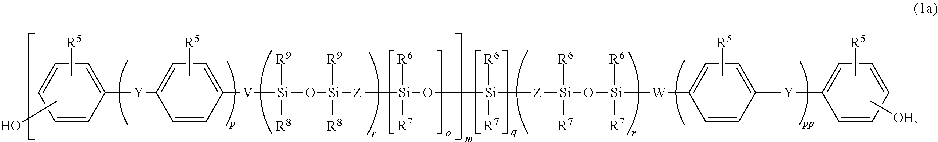

wherein
R⁵ represents hydrogen or C₁- to C₄-alkyl, C₁- to C₃-alkoxy, preferably hydrogen, methoxy or methyl,
R⁶, R⁷, R⁸ and R⁹ each independently of one another represent C₁- to C₄-alkyl or C₆- to C₁₂-aryl, preferably methyl or phenyl,
Y represents a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or represents a C₅- to C₆-cycloalkylidene radical which may be mono- or polysubstituted with C₁- to C₄-alkyl, preferably represents a single bond, —O—, isopropylidene or a C₅- to C₆-cycloalkylidene radical which may be mono- or polysubstituted with C₁- to C₄-alkyl,
V represents oxygen, C₂- to C₆-alkylene or C₃- to C₆-alkylidene, preferably oxygen or C₃-alkylene,
p, q and r are each independently 0 or 1,
when q=0, W represents a single bond, when q=1 and r=0, W represents oxygen, C₂- to C₆-alkylene or C₃- to C₆-alkylidene, preferably oxygen or C₃-alkylene,
when q=1 and r=1, W and V each independently represent C₂- to C₆-alkylene or C₃- to C₆-alkylidene, preferably C₃-alkylene,
Z represents a C₁- to C₆-alkylene, preferably C₂-alkylene,
represents an average number of repeating units from 10 to 500, preferably 10 to 100, and
m is an average number of repeat units from 1 to 10, preferably 1 to 6, more preferably 1.5 to 5. It is likewise possible to use to the diphenols in which two or more siloxane blocks of general formula (1a) are bonded to one another via terephthalic acid and/or isophthalic acid to form ester groups.

Especial preference is given to (poly)siloxanes of formulae (2) and (3)

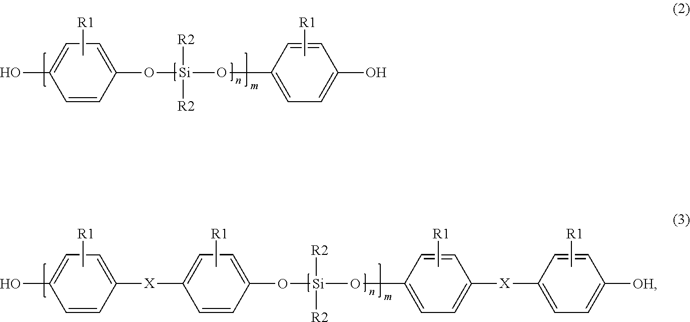

wherein R1 represents hydrogen, C₁- to C₄-alkyl, preferably hydrogen or methyl and especially preferably hydrogen,
R2 independently at each occurrence represents aryl or alkyl, preferably methyl,
X represents a single bond, —SO₂—, —CO—, —O—, —S—, C₁- to C₆-alkylene, C₂- to C₅-alkylidene or C₆- to C₁₂-arylene which may optionally be fused to further aromatic rings containing heteroatoms,
X preferably represents a single bond, C₁- to C₅-alkylene, C₂- to C₅-alkylidene, C₅- to C₁₂-cycloalkylidene, —O—, —SO— —CO—, —S—, —SO₂—, particularly preferably X represents a single bond, isopropylidene, C₅- to C₁₂-cycloalkylidene or oxygen and very particularly preferably isopropylidene,
n represents an average number from 10 to 400, preferably 10 to 100, especially preferably 15 to 50 and
m represents an average number from 1 to 10, preferably from 1 to 6 and especially preferably from 1.5 to 5.

The siloxane block may similarly preferably be derived from the following structure

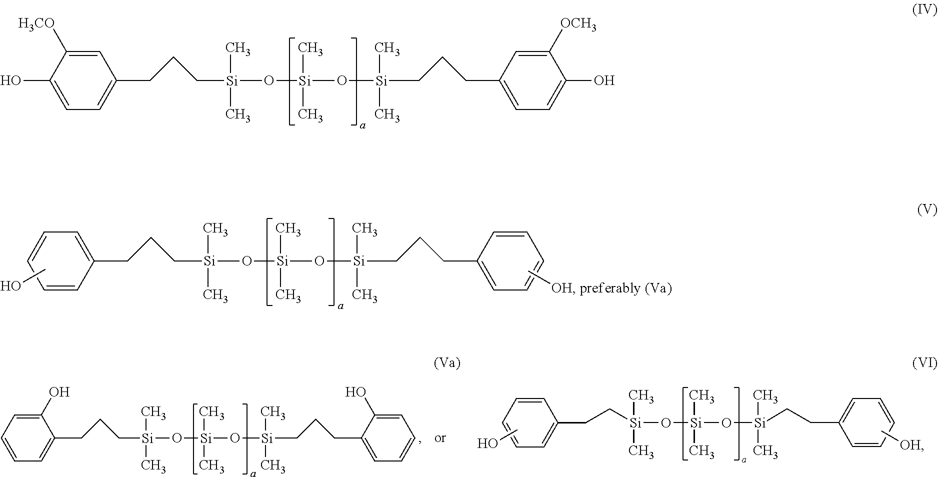

wherein a in formulae (IV), (V) and (VI) represents an average number of 10 to 400, preferably 10 to 100 and particularly preferably 15 to 50.

It is likewise preferable when at least two identical or different siloxane blocks of general formulae (IV), (V) or (VI) are bonded to one another via terephthalic acid and/or isophthalic acid to form ester groups.

It is likewise preferable when in formula (1a) p=0, V represents C₃-alkylene, r=1, Z represents C₂-alkylene, R⁸ and R⁹ represent methyl, q=1, W represents C₃-alkylene, m=1, R⁵ represents hydrogen or C₁- to C₄-alkyl, preferably hydrogen or methyl, R⁶ and R⁷ each independently of one another represent C₁- to C₄-alkyl, preferably methyl, and o is 10 to 500.

Copolycarbonates having monomer units of formula (1a) and in particular also the production thereof are described in WO 2015/052106 A2.

The thermoplastic polycarbonates, including the thermoplastic aromatic polyester carbonates, preferably have weight-average molecular weights M_{W} of 15 000 g/mol to 40 000 g/mol, more preferably up to 34 000 g/mol, particularly preferably of 17 000 g/mol to 33 000 g/mol, in particular of 19 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

To achieve incorporation of additives, component A is preferably employed in the form of powders, pellets or mixtures of powders and pellets.

Component B

Compositions according to the invention contain 3.0% by weight to 40.0% by weight, preferably 5.0% by weight to 35% by weight, more preferably 6.0% by weight to 30% by weight, yet more preferably 7.0% by weight to 25% by weight, yet more preferably 8.0% by weight to 22% by weight, particularly preferably 9.0% by weight to 20% by weight, very particularly preferably 10.0% by weight to 15.0% by weight, exceptionally preferably 10.0% by weight to 12.0% by weight, of titanium dioxide.

The titanium dioxide of component B of the compositions according to the invention preferably has an average particle size D₅₀, determined by scanning electron microscopy (STEM), of 0.1 to 5 μm, preferably 0.2 μm to 0.5 μm. However, the titanium dioxide may also have a different particle size, for example an average particle size D₅₀, determined by scanning electron microscopy (STEM), of ≥0.5 μm, for instance 0.65 to 1.15 μm.

The titanium dioxide preferably has a rutile structure.

The titanium dioxide used in accordance with the invention is a white pigment, Ti(IV)O₂. Colored titanium dioxides contain not only titanium but also elements such as Sb, Ni, Cr in significant amounts, so as to result in a color impression other than “white”. It will be appreciated that traces of other elements may also be present as impurities in the titanium dioxide white pigment. However, these amounts are so small that the titanium dioxide does not take on any tint as a result.

Suitable titanium dioxides are preferably those produced by the chloride process, hydrophobized, specially aftertreated and suitable for use in polycarbonate. Instead of sized titanium dioxide, compositions according to the invention may in principle also employ unsized titanium dioxide or a mixture of both. However, the use of sized titanium dioxide is preferred.

Possible surface modifications of titanium dioxide include inorganic and organic modifications. These include for example aluminum- or polysiloxane-based surface modifications. An inorganic coating may contain 0.0% by weight to 5.0% by weight of silicon dioxide and/or aluminum oxide. An organic-based modification may contain 0.0% by weight to 3.0% by weight of a hydrophobic wetting agent. The titanium dioxide preferably has an oil absorption number determined according to DIN EN ISO 787-5:1995-10, of 12 to 18 g/100 g of titanium dioxide, more preferably of 13 to 17 g/100 g of titanium dioxide, particularly preferably of 13.5 to 15.5 g/100 g of titanium dioxide.

Particular preference is given to titanium dioxide having the standard designation R² according to DIN EN ISO 591-1:2001-08, which is stabilized with aluminum and/or silicon compounds and has a titanium dioxide content of at least 96.0% by weight. Such titanium dioxides are available under the brand names Kronos 2233 and Kronos 2230.

Component C

The compositions according to the invention contain epoxidized triacylglycerol as component C. Component C may be a specific triacylglycerol or a mixture of different epoxy-containing (“epoxidized”) triacylglycerols. It is preferably a mixture of different triacylglycerols. Component C preferably contains a mixture of triesters of glycerol with oleic acid, linoleic acid, linolenic acid, palmitic acid and/or stearic acid. More preferably, the esters of component C comprise only esters of glycerol with the fatty acids mentioned. Component C is particularly preferably introduced into the compositions according to the invention in the form of epoxidized soybean oil (C1). The CAS number of epoxidized soybean oil is 8013-07-8.

The epoxy groups in component C may be introduced by methods familiar to those skilled in the art. These methods in particular are epoxidation with peroxides or peracids, that is to say esters of glycerol with carboxylic acids containing double bonds are reacted with peroxides or peracids. In the process, some or all of the C═C double bonds in the triacylglycerols react to form epoxy groups. The triacylglycerols are therefore partially or completely epoxidized. Preferably, at least 90%, more preferably at least 95%, more preferably still at least 98%, of the C═C double bonds originating from the unsaturated carboxylic acids in the triacylglycerols are epoxidized. Component C is preferably a mixture of different compounds, as is the case, for example, with the use of epoxidized soybean oil. The OH numbers of these mixtures are preferably between 180 and 300 mg KOH/g (method 2011-0232602-92D of Currenta GmbH & Co. OHG, Leverkusen, corresponding to DIN EN ISO 2554:1998-10 with pyridine as solvent). The acid numbers of these mixtures are preferably below 1 mg KOH/g; they are more preferably ≤0.5 mg KOH/g, determined by means of DIN EN ISO 2114:2006-11. The iodine number of the mixtures according to Wijs is preferably ≤5.0 g of iodine/100 g, more preferably ≤3.0 g of iodine/100 g (method 2201-0152902-95D of Currenta GmbH & Co. 0H3, Leverkusen). The oxirane number determined according to DIN EN 1877-1:2000-12 is preferably 5 to 10 g O₂/100 g, particularly preferably 6.3 to 8.0 g O₂/100 g.

The polycarbonate-containing compositions preferably contain at least 0.01% by weight, more preferably 0.01% by weight to 5.0% by weight, yet more preferably 0.05% by weight to 2.0% by weight, particularly preferably 0.1% by weight to 0.8% by weight, very particularly preferably up to 0.6% by weight, in particular up to 0.4% by weight, of component C

Component D

The compositions according to the invention may additionally contain heat stabilizers D. Suitable heat stabilizers are in particular phosphorus-based stabilizers selected from the group of the phosphates, phosphites, phosphonites, phosphines and mixtures thereof. It is also possible to use mixtures of different compounds from one of these subgroups, for example two phosphites.

Heat stabilizers preferably used are phosphorus compounds having the oxidation number+III, in particular phosphines and/or phosphites.

Particularly preferably suitable heat stabilizers are triphenylphosphine, tris(2,4-di-tert-butylphenyl) phosphite (Irgafos® 168), tetrakis(2,4-di-tert-butylphenyl)-[1,1-biphenyl]-4,4′-diylbisphosphonite, octadecyl 3-(3,5-di-tert-butyl-4-hydroxyphenyl)propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36).

They may be employed alone or in admixture, for example Irganox® B900 (mixture of Irgafos® 168 and Irganox® 1076 in a 4:1 ratio) or Doverphos® S-9228 with Irganox® B900/Irganox® 1076.

The heat stabilizers are preferably employed in amounts of up to 1.0% by weight, more preferably 0.003% by weight to 1.0% by weight, yet more preferably 0.005% by weight to 0.5% by weight, particularly preferably 0.01% by weight to 0.2% by weight.

Component E

The compositions preferably contain at least one flame retardant selected from the group of alkali metal, alkaline earth metal or ammonium salts of aliphatic/aromatic sulfonic acid, sulfonamide and sulfonimide derivatives or else combinations thereof.

According to the invention, “derivatives” is here and elsewhere to be understood as meaning compounds where the molecular structure has a different atom or a different group of atoms in place of an H-atom or a functional group or where one or more atoms/group of atoms have been removed. The parent compound thus remains recognizable.

As flame retardant, compositions according to the invention particularly preferably comprise one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, or mixtures thereof.

Preference is given to using sodium or potassium perfluorobutanesulfate, sodium or potassium perfluorooctanesulfate, sodium or potassium diphenylsulfone sulfonate, or mixtures thereof. Very particular preference is given to potassium perfluoro-1-butanesulfonate, which is commercially available, inter alia, as Bayowet® C4 from Lanxess, Leverkusen, Germany.

The amounts of alkali metal, alkaline earth metal and/or ammonium salts of aliphatic/aromatic sulfonic acid, sulfonamide and sulfonimide derivatives in the composition, if employed, preferably sum to 0.05% by weight to 0.5% by weight, more preferably 0.06% by weight to 0.3% by weight, particularly preferably 0.06% by weight to 0.2% by weight, particularly preferably 0.065% by weight to 0.12% by weight.

Component F

Optionally also present in addition are further additives, preferably in amounts of up to to 10.0% by weight, more preferably 0.1% by weight to 6.0% by weight, particularly preferably 0.1% by weight to 3.0% by weight, very particularly preferably 0.2% by weight to 1.0% by weight, in particular up to 0.5% by weight, of other customary additives (“further additives”). The group of further additives does not include any heat stabilizers since these are already described as component D. Likewise, the group of further additives comprises no flame retardants of component E. It will also be appreciated that component F also contains no titanium dioxide and no epoxy-containing triacylglycerol and no epoxidized soybean oil, since these are already described as component B and C/C1.

Such further additives, such as are typically added in the case of polycarbonates, are in particular antioxidants, demolding agents, flame retardants distinct from component E, anti-drip agents such as polytetrafluoroethylene (Teflon) or SAN-encapsulated PTFE (for example Blendex 449), UV absorbers, IR absorbers, impact modifiers, antistats, optical brighteners, fillers distinct from component B such as for example talc, silicates or quartz, light scattering agents, dyes such as organic pigments, inorganic pigments distinct from component B and/or additives for laser marking. Such additives are described for example in EP-A 0 839 623, WO-A 96/15102, EP-A 0 500 496 or in “Plastics Additives Handbook”, Hans Zweifel, 5th Edition 2000, Hanser Verlag, Munich, in particular anti-drip agents in the amounts customary for polycarbonate. These additives may be added individually or else in admixture.

Further preferred additives are specific UV stabilizers having minimum transmittance below 400 nm and maximum transmittance above 400 nm. Ultraviolet absorbers particularly suitable for use in the composition according to the invention are benzotriazoles, triazines, benzophenones and/or arylated cyanoacrylates.

Particularly suitable ultraviolet absorbers are hydroxybenzotriazoles, such as 2-(3′,5′-bis(1,1-dimethylbenzyl)-2′-hydroxyphenyl)benzotriazole (Tinuvin® 234, BASF SE, Ludwigshafen), 2-(2′-hydroxy-5′-(tert-octyl)phenyl)benzotriazole (Tinuvin® 329, BASF SE, Ludwigshafen), bis(3-(2H-benzotriazolyl)-2-hydroxy-5-tert-octyl)methane (Tinuvin® 360, BASF SE, Ludwigshafen), 2-(4,6-diphenyl-1,3,5-triazin-2-yl)-5-(hexyloxy)phenol (Tinuvin® 1577, BASF SE, Ludwigshafen), 2-(5-chloro-2H-benzotriazol-2-yl)-6-(1,1-dimethylethyl)-4-methylphenol (Tinuvin® 326, BASF SE, Ludwigshafen), and also benzophenones such as 2,4-dihydroxybenzophenone (Chimassorb® 22, BASF SE, Ludwigshafen) and 2-hydroxy-4-(octyloxy)benzophenone (Chimassorb® 81, BASF SE, Ludwigshafen), 2,2-bis[[(2-cyano-1-oxo-3,3-diphenyl-2-propenyl)oxy]methyl]-1,3-propanediyl ester (9CI) (Uvinul 3030, BASF SE, Ludwigshafen), 2-[2-hydroxy-4-(2-ethylhexyl)oxy]phenyl-4,6-di(4-phenyl)phenyl-1,3,5-triazine (Tinuvin 1600, BASF SE, Ludwigshafen), tetraethyl 2,2′-(1,4-phenylenedimethylidene)bismalonate (Hostavin B-Cap, Clariant AG) or N-(2-ethoxyphenyl)-N′-(2-ethylphenyl)ethanediamide (Tinuvin 312, CAS no. 23949-66-8, BASF SE, Ludwigshafen).

Particularly preferred specific UV stabilizers are Tinuvin 360, Tinuvin 329, Tinuvin 326, Tinuvin 1600, Tinuvin 312, Uvinul 3030 and/or Hostavin B-Cap, very particularly preferably Tinuvin 329 and Tinuvin 360.

It is also possible to use mixtures of the abovementioned ultraviolet absorbers.

If UV absorbers are present, the composition preferably contains ultraviolet absorbers in an amount of up to 0.8% by weight, preferably 0.05% by weight to 0.5% by weight, more preferably 0.08% by weight to 0.4% by weight, very particularly preferably 0.1% by weight to 0.35% by weight, based on the overall composition.

The compositions of the invention may also contain phosphates or sulfonic esters as transesterification stabilizers. It is preferable when triisooctyl phosphate is present as a transesterification stabilizer.

Triisooctyl phosphate is preferably used in amounts of 0.003% by weight to 0.05% by weight, more preferably 0.005% by weight to 0.04% by weight and particularly preferably of 0.01% by weight to 0.03% by weight, based on the total composition.

The composition may be free from pentaerythritol tetrastearate and glycerol monostearate, in particular free from demolding agents customarily used for polycarbonate, further free from any demolding agents. The compositions according to the invention particularly preferably contain at least one heat stabilizer (component D) and/or at least one flame retardant of component E.

The compositions according to the invention may also contain an impact modifier as a further additive (component F). Examples of impact modifiers are: acrylate core-shell systems or butadiene rubbers (Paraloid series from DOW Chemical Company); olefin-acrylate copolymers, for example Elvaloy® series from DuPont; silicone acrylate rubbers, for example Metablen® series from Mitsubishi Rayon Co., Ltd.

At least one anti-drip agent is preferably also present as a further additive of component F, more preferably in an amount of 0.05% by weight to 1.5% by weight, in particular 0.1% by weight to 1.0% by weight.

It will be appreciated that the thermoplastic compositions according to the invention may in principle also contain blend partners. Examples of thermoplastic polymers suitable as blend partners are polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, poly- or copolyacrylates, poly- or copolymethacrylate, for example poly- or copolymethylmethacrylates (such as PMMA), and also copolymers with styrene, for example transparent polystyrene-acrylonitrile (PSAN), thermoplastic polyurethanes and/or polymers based on cyclic olefins (e.g. TOPAS®, a commercial product from Ticona).

Particularly preferred compositions consist of
A) 69.79% by weight to 94.79% by weight of aromatic polycarbonate,
B) 5.0% by weight to 30.0% by weight of titanium dioxide,
C) 0.01% by weight to 2.0% by weight of epoxidized triacylglycerol, in particular introduced into the composition in the form of epoxidized soybean oil,
D) 0.0% by weight to 1.0% by weight of heat stabilizer,
E) 0.1% by weight to 0.5% by weight of flame retardant selected from the group of alkali metal, alkaline earth metal or ammonium salts of aliphatic or aromatic sulfonic acid, sulfonamide or sulfonimide derivatives and combinations thereof and
F) 0.1% by weight to 3.0% by weight of further additives, wherein at least anti-drip agent is present as a further additive.

Exceptionally preferred compositions consist of
A) 84.7% by weight to 89.7% by weight of aromatic polycarbonate,
B) 10.0% by weight to 15.0% by weight of titanium dioxide,
C) 0.1% by weight to 2.0% by weight of epoxidized triacylglycerol, in particular introduced into the composition in the form of epoxidized soybean oil,
D) 0.0% by weight to 1.0% by weight of heat stabilizer,
E) 0.1% by weight to 0.5% by weight of flame retardant selected from the group of alkali metal, alkaline earth metal or ammonium salts of aliphatic or aromatic sulfonic acid, sulfonamide or sulfonimide derivatives and combinations thereof and
F) 0.1% by weight to 3.0% by weight of further additives, wherein at least anti-drip agent is present as a further additive.

Production of the compositions according to the invention comprising components A to C (or C1) and optionally D and/or optionally E and/or optionally F and optionally blend partners is effected by commonly used incorporation processes by combination, mixing and homogenization of the individual constituents, wherein in particular the homogenization preferably takes place in the melt under the influence of shear forces. Combination and mixing is optionally effected prior to melt homogenization using powder pre-mixes.

It is also possible to use premixes of pellets, or of pellets and powders, with components B, C or C1 and optionally D, E and/or F.

It is also possible to use pre-mixes produced from solutions of the mixture components in suitable solvents where homogenization is optionally effected in solution and the solvent is then removed.

In particular, components B to F of the composition according to the invention may be introduced into the polycarbonate, optionally into the polycarbonate with blend partners, by known methods or as a masterbatch.

The use of masterbatches to incorporate the components B to F, individually or in admixture, is preferred.

In this connection, the composition according to the invention can be combined, mixed, homogenized and subsequently extruded in customary apparatuses such as screw extruders (ZSK twin-screw extruders for example), kneaders or Brabender or Banbury mills. The extrudate may be cooled and comminuted after extrusion. It is also possible to premix individual components and then to add the remaining starting materials individually and/or likewise mixed.

The combining and mixing of a pre-mix in the melt may also be effected in the plasticizing unit of an injection molding machine. In this case, the melt is directly converted into a molded article in the subsequent step.

The compositions according to the invention can be processed in a customary manner in standard machines, for example in extruders or injection molding machines, to give any molded articles, for example films, sheets or bottles.

The compositions/molded parts made of the compositions appear “brilliant white” to the observer.

Production of the molded parts is preferably effected by injection molding, extrusion or from solution in a casting process.

The compositions according to the invention are suitable for producing multilayered systems. The polycarbonate-containing composition is applied in one or more layers to a molded article made of a plastic or itself serves as a substrate layer upon which one or more further layers are applied. Application may be carried out at the same time as or immediately after the molding of the molded article, for example by in-mold coating of a film, coextrusion or multicomponent injection molding. However, application can also take place onto the finished molded main body, for example by lamination with a film, insert molding of an existing molded article or by coating from a solution.

The compositions according to the invention are for producing components in the lighting sector, such as lamp reflectors, in particular LED lamps or LED arrays, in the automotive sector, for example for panels, switches, headlight reflectors or frames, and for producing frames or frame parts or housing or housing parts in the EE (electrical/electronic) and IT area. On account of the very good reflectance values the compositions according to the invention are preferably used for producing reflectors.

These and other molded parts consisting of the compositions according to the invention or, for example in the case of multicomponent injection molding, comprising these, including moldings constituting a layer of a multilayered system or an element of an abovementioned component or such a component as a whole and made of (“consisting of”) these compositions according to the invention, likewise form part of the subject matter of the present application. The compositions according to the invention are also employable as a 3D printing material in the form of filaments, as pellets or powder.

The embodiments described hereinabove for the compositions according to the invention also apply—where applicable—to the uses according to the invention.

These are the use of epoxidized triacylglycerol, in particular in the form of epoxidized soybean oil, for improving the reflectance of titanium dioxide-containing polycarbonate compositions, wherein the reflectance is preferably determined according to ASTM E 1331-2015 at a layer thickness of 2 mm, the use of epoxidized triacylglycerol, in particular in the form of epoxidized soybean oil, for improving the yellowness index, preferably determined according to ASTM E 313-15 (observer 10°/illuminant: D65) on sample sheets having a layer thickness of 2 mm, wherein both objectives may be standalone objectives or combined objectives.

The examples which follow are intended to illustrate the invention but without limiting said invention.

### Examples

1. Description of Raw Materials and Test Methods

The polycarbonate-based compositions described in the following examples were produced by compounding on a Berstorff ZE 25 extruder at a throughput of 10 kg/h. The melt temperature was 275° C.

Component A-1: Linear polycarbonate based on bisphenol A having a melt volume-flow rate MVR of 19 cm³/(10 min) (according to ISO 1133:2012-03, at a test temperature of 300° C. and under a load of 1.2 kg).

Component A-2: Linear polycarbonate powder based on bisphenol A having a melt volume-flow rate MVR of 19 cm³/(10 min) (according to ISO 1133:2012-03, at a test temperature of 300° C. and with 1.2 kg load).

Component A-3: Linear polycarbonate powder based on bisphenol A having a melt volume-flow rate MVR of 19 cm³/(10 min) (according to ISO 1133:2012-03, at a test temperature of 300° C. and 1.2 kg loading) containing 250 ppm of triphenylphosphine from BASF SE as Component D1.

Component B: Kronos 2230 titanium from Kronos Titan GmbH, Leverkusen.

Component C: Epoxidized soybean oil (“D65 soybean oil”) from Avokal GmbH, Wuppertal, having an acid number of ≤0.5 mg KOH/g, determined by DIN EN ISO 2114:2006-11, an oxirane value (epoxy oxygen EO, calculated from the epoxy value EEW, indicates how many grams of oxygen are present per 100 g of oil; EEW determined according to DIN EN 1877-1:2000-12) of ≥6.3 g O₂/100 g. Predominantly fully epoxidized triacylglycerols, which are a mixture of triesters of glycerol with oleic acid, linoleic acid, linolenic acid, palmitic acid and/or stearic acid.

Component D1: Triphenylphosphine, commercially available from BASF SE, Ludwigshafen.

Component E1: Potassium perfluoro-1-butanesulfonate, commercially available as Bayowet® C4 from Lanxess AG, Leverkusen, Germany, CAS no. 29420-49-3.

Component F1: Blendex® B449 (about 50% by weight of PTFE and about 50% by weight of SAN [formed from 80% by weight of styrene and 20% by weight of acrylonitrile]) from Chemtura Corporation. Anti-drip agent.

Component F2: Paraloid EXL2300 from Dow. Acrylic core/shell impact modifier based on butyl acrylate rubber.

Component F3: Tinuvin 329, UV stabilizer having a benzotriazole structure, commercially available from BASF SE, Ludwigshafen.

Melt volume-flow rate (MVR) was determined according to ISO 1133:2012-03 (predominantly at a test temperature of 300° C., mass 1.2 kg) using a Zwick 4106 instrument from Zwick Roell. In addition, the MVR value was measured after a preheating time of 20 minutes (IMVR20′). This is a measure of melt stability under elevated thermal stress.

Determination of ash content was carried out according to DIN 51903:2012-11 (850° C., hold for 30 min).

The total reflectance spectrum was measured on the basis of the standard ASTM E 1331-04 using a spectrophotometer. The total transmittance spectrum was measured on the basis of the standard ASTM E 1348-15 using a spectrophotometer. The layer thickness was 2 mm.

The transmittance or reflectance spectrum thus obtained was used to calculate visual transmittance Ty (illuminant D65, observer 10°) or visual reflectance Ry (illuminant D65, observer 10°) in each case according to ASTM E 308-08. This also applies to the color values L*a*b*.

Shine was determined according to ASTM D 523-14.

Yellowness index (Y.I.) was determined according to ASTM E 313-10 (observer: 10°/illuminant: D65) at a layer thickness of 2 mm.

The glass transition temperature T_{g} was measured by DSC in a differential scanning calorimeter (Mettler DSC 3+) at a heating rate of 10 K/min (atmosphere: 50 ml/min of nitrogen) in standard crucibles over a temperature range of 0° C.-280° C. The value determined in the 2nd heating operation was reported. Measurement was carried out according to ISO 11357-2:2014-07.

The flammability of the samples investigated was also assessed and classified, specifically according to UL94. To this end, test specimens measuring 125 mm×13 mm×d (mm) were produced, where the thickness d is the smallest wall thickness in the intended application. A VO classification means that the flame self-extinguishes after not more than 10 s. There are no burning drips. Afterglow after second flame contact has a duration of not more than 30 s.

The specimen plaques were in each case produced by injection molding at the melt temperatures reported in the tables which follow.

In the following table the inventive experiments are labeled “E” and the comparative examples are labelled “V”.

TABLE 1

| | | | Example | | | |
|---|---|---|---|---|---|---|
| | | | V-1 | E-2 | E-3 | E-4 |
| | | | Component | | | |
| | | | % by | % by | % by | % by |
| | | | wt | wt | wt | wt |
| A1 | | | 81.00 | 81.00 | 81.00 | 81.00 |
| A2 | | | 7.00 | 6.90 | 6.80 | 6.60 |
| B | | | 12.00 | 12.00 | 12.00 | 12.00 |
| C | | | | 0.10 | 0.20 | 0.40 |
| Test | Condition | Standard/unit | | | | |
| Ash content (average) | | % | 11.88 | 11.33 | 11.9 | 11.7 |
| MVR | 300° C.; 1.20 kg; 7 min | cm³/(10 min) | 21.7 | 21.3 | 21.3 | 22.3 |
| IMVR20′ | 300° C.; 1.20 kg; 20 min | cm³/(10 min) | 28.1 | 28.2 | 26.9 | 31.8 |
| Reflectance | Hunter | ASTM E 1331 | | | | |
| | UltraScanPRO, | with shine | | | | |
| | Diffuse/8°; D65; 10° | | | | | |
| L* (ro) | | | 98.43 | 98.62 | 98.67 | 98.7 |
| a* (ro) | | | −0.61 | −0.63 | −0.64 | −0.65 |
| b* (ro) | | | 2.2 | 2.13 | 2.08 | 2.11 |
| Reflectance (ro) | | % | 95.99 | 96.46 | 96.6 | 96.69 |
| Yellowness index (ro) | | | 3.61 | 3.46 | 3.35 | 3.4 |
| 60° Shine (ro) | | | 101 | 101 | 101 | 101 |

A comparison of V-1, without epoxidized triacylglycerol, with E-2 to E-4 shows that a significant increase in the reflectance value from 95.99% to 96.69% is achieved with an increasing amount of epoxidized triacylglycerol. The addition of epoxidized triacylglycerol also slightly improves the yellowness index. Surprisingly, the compositions according to the invention are brilliant white in spite of quite high Y.I. values. There is no discernible effect on viscosity.

TABLE 2

| | | | Example | | | | |
|---|---|---|---|---|---|---|---|
| | | | V-5 | E-6 | E-7 | E-8 | E-9 |
| | | | Component | | | | |
| | | | % by | % by | % by | % by | % by |
| | | | wt | wt | wt | wt | wt |
| A2 | | | 8.00 | 7.35 | 7.285 | 7.2 | 7.23 |
| A3 | | | 80.00 | 80.00 | 80.00 | 80.00 | 80.00 |
| B | | | 12.00 | 12.00 | 12.00 | 12.00 | 12.00 |
| C | | | | 0.15 | 0.15 | 0.15 | 0.15 |
| E1 | | | | | 0.065 | 0.10 | 0.12 |
| F1 | | | | 0.50 | 0.50 | 0.50 | 0.50 |
| Test | Condition | Standard/unit | | | | | |
| Ash content (average) | 300° C.; 1.20 kg; 7 min | % | 11.94 | 11.7 | 11.67 | 11.99 | 12.02 |
| MVR | 300° C.; 1.20 kg; 20 min | cm³/(10 min) | 20.7 | 10.6 | 12.3 | 13.4 | 14.1 |
| IMVR20′ | | cm³/(10 min) | 24.9 | 12 | 15.8 | 17.6 | 20.3 |
| ΔMVR/IMVR20′ | | | 4.2 | 1.4 | 3.5 | 4.2 | 6.2 |
| Fire performance | | | | | | | |
| UL94-V Rating (ro) | 1.50 mm | | V-2 | V-1 | V-0 | V-0 | V-0 |
| UL94-V Rating (ro) | 1.60 mm | | V-2 | V-1 | V-0 | V-0 | V-0 |
| UL94-V Rating (ro) | 1.80 mm | | V-2 | V-0 | V-0 | V-0 | V-0 |
| UL94-V Rating (ro) | 2.00 mm | | V-2 | V-0 | V-0 | V-0 | V-0 |
| Optical data | | | | | | | |
| Reflectance (2 mm) | Hunter | ASTM E 1331 | | | | | |
| | UltraScanPRO, | with shine | | | | | |
| | Diffuse/8°; D65; 10° | | | | | | |
| L* (ro) | | | 98.62 | 98.77 | 98.64 | 98.66 | 98.64 |
| a* (ro) | | | −0.62 | −0.67 | −0.66 | −0.65 | −0.65 |
| b* (ro) | | | 2.02 | 2.05 | 2.08 | 2.1 | 2.08 |
| Reflectance (ro) | | % | 96.47 | 96.84 | 96.51 | 96.57 | 96.53 |
| Yellowness index (ro) | | | 3.26 | 3.27 | 3.34 | 3.37 | 3.34 |
| 60° Shine (ro) | | | 101 | 101 | 101 | 101 | 101 |

The addition of epoxidized triacylglycerol does not reduce the effect of the added flame retardant. The presence of epoxidized triacylglycerol always results in achievement of higher reflectance values than the absence of epoxidized triacylglycerol (V-5), even in the presence of different amounts of flame retardant (E-6 to E-9). However, only the presence of flame retardant makes it possible for compositions having the same titanium dioxide content to achieve a UL94 V-0 classification at a wall thickness of only 1.5 mm.

TABLE 3

| | | | Example | | | | | |
|---|---|---|---|---|---|---|---|---|
| | | | V-10 | V-11 | V-12 | V-13 | E-14 | E-15 |
| | | | Component | | | | | |
| | | | % by | % by | % by | % by | % by | % by |
| | | | wt | wt | wt | wt | wt | wt |
| A2 | | | 8.00 | 7.435 | 7.40 | 5.435 | 7.285 | 5.285 |
| A3 | | | 80.00 | 80.00 | 80.00 | 80.00 | 80.00 | 80.00 |
| B | | | 12.00 | 12.00 | 12.00 | 12.00 | 12.00 | 12.00 |
| C | | | | | | | 0.15 | 0.15 |
| E1 | | | | 0.065 | 0.10 | 0.065 | 0.065 | 0.065 |
| F1 | | | | 0.50 | 0.50 | 0.50 | 0.50 | 0.50 |
| F2 | | | | | | 2.00 | | 2.00 |
| Test | Condition | Standard/unit | | | | | | |
| Ash content (average) | 850° C.; 0.5 h | % | 11.57 | 11.75 | 11.66 | 11.78 | 11.94 | 11.87 |
| (ro) | | | | | | | | |
| MVR | 300° C.; 1.20 kg; 7 min | cm³/(10 min) | 21.1 | 12.3 | 12.9 | 8.0 | 11.9 | 8.2 |
| IMVR20′ | 300° C.; 1.20 kg; 20 min | cm³/(10 min) | 25.8 | 15 | 16.3 | 9.6 | 15.7 | 10.4 |
| ΔMVR/IMVR20′ | | | 4.7 | 2.7 | 3.4 | 1.6 | 3.8 | 2.2 |
| UL94-V | 1.50 mm | | | | | | | |
| Rating (ro) | | | V-2 | V-0 | V-0 | V-0 | V-0 | V-0 |
| UL94-V | 2.00 mm | | | | | | | |
| Rating (ro) | | | V-2 | V-0 | V-0 | V-0 | V-0 | V-0 |
| Reflectance | Hunter | ASTM E 1331 | | | | | | |
| | UltraScanPRO, | with shine | | | | | | |
| | Diffuse/8°; D65; 10° | | | | | | | |
| Sample thickness (ro) | | mm | 2 | 2 | 2 | 2 | 2 | 2 |
| L* (ro) | | | 98 | 98.24 | 98.25 | 98.42 | 98.32 | 98.48 |
| a* (ro) | | | −0.5 | −0.55 | −0.52 | −0.58 | −0.59 | −0.63 |
| b* (ro) | | | 2.19 | 2.18 | 2.22 | 2.08 | 2.1 | 1.94 |
| Reflectance (ro) | | % | 94.91 | 95.53 | 95.55 | 95.97 | 95.71 | 96.12 |
| Yellowness index (ro) | | | 3.68 | 3.61 | 3.7 | 3.41 | 3.43 | 3.10 |
| 60° Shine (ro) | | | 102 | 102 | 102 | 100 | 102 | 100 |

A comparison of V-13 with E-15 shows that the addition of epoxidized triacylglycerol increases the reflectance value without any significant effect on the MVR value. The yellowness index is improved.

TABLE 4

| | | | Example | | | | | | | | |
|---|---|---|---|---|---|---|---|---|---|---|---|
| | | | V-16 | E-17 | E-18 | V-19 | E-20 | E-21 | V-22 | E-23 | E-24 |
| | | | Component | | | | | | | | |
| | | | % by | % by | % by | % by | % by | % by | % by | % by | % by |
| | | | wt | wt | wt | wt | wt | wt | wt | wt | wt |
| A1 | | | 88.00 | 88.00 | 88.00 | 83.00 | 83.00 | 83.00 | 73.00 | 73.00 | 73.00 |
| A2 | | | 7.00 | 6.90 | 6.80 | 7.00 | 6.90 | 6.80 | 7.00 | 6.90 | 6.80 |
| B | | | 5.00 | 5.00 | 5.00 | 10.00 | 10.00 | 10.00 | 20.00 | 20.00 | 20.00 |
| C | | | | 0.10 | 0.20 | | 0.10 | 0.20 | | 0.10 | 0.20 |
| Test | Condition | Standard/unit | | | | | | | | | |
| Ash content (average) | 850° C./0.5 h | % | 4.49 | 4.3 | 4.51 | 8.94 | 9.08 | 9.23 | 18.44 | 18.34 | 19.87 |
| (ro) | | | | | | | | | | | |
| MVR | 300° C.; 1.20 | cm³/(10 min) | 20.8 | 20.3 | 21.2 | 21.4 | 21.6 | 21.3 | 24 | 22.7 | 21.3 |
| | kg; 7 min | | | | | | | | | | |
| IMVR20′ | 300° C.; 1.20 | cm³/(10 min) | 24.9 | 22.8 | 23.5 | 25 | 25.6 | 26.2 | 26.9 | 26.8 | 28.1 |
| | kg; 20 min | | | | | | | | | | |
| ΔMVR/IMVR20′ | | | 4.1 | 2.5 | 2.3 | 3.6 | 4 | 4.9 | 2.9 | 4.1 | 6.8 |
| Reflectance | Hunter | ASTM E 1331 | | | | | | | | | |
| | UltraScanPRO, | with shine | | | | | | | | | |
| | Diffuse/8°; | | | | | | | | | | |
| | D65; 10° | | | | | | | | | | |
| Sample thickness (ro) | | mm | 2 | 2 | 2 | 2 | 2 | 2 | 2 | 2 | 2 |
| L* (ro) | | | 97.56 | 97.70 | 97.93 | 97.84 | 98.08 | 98.16 | 98.21 | 98.30 | 98.47 |
| Reflectance (ro) | | % | 93.82 | 94.17 | 94.75 | 94.52 | 95.12 | 95.31 | 95.43 | 95.68 | 96.09 |
| Yellowness index (ro) | | | 4.12 | 4.06 | 3.83 | 3.98 | 3.83 | 3.80 | 3.60 | 3.52 | 3.27 |
| 60° Shine (ro) | | | 103 | 103 | 103 | 102 | 102 | 100 | 99 | 100 | 99 |

The addition of epoxidized triacylglycerol (compare V-16 with E-17, E-18; V-19 with E-20, E-21, V-22 with E-23, E-24) causes a significant increase in reflectance At the same time, the yellowness index is improved. There is no relevant change in the MVR value.

TABLE 5

| | | | Example | | |
|---|---|---|---|---|---|
| | | | V-25 | E-26 | E-27 |
| | | | % by | % by | % by |
| Component | | | wt | wt | wt |
| A1 | | | 81.00 | 81.00 | 81.00 |
| A2 | | | 7.00 | 6.80 | 4.80 |
| B | | | 12.00 | 12.00 | 12.00 |
| C | | | | 0.20 | 0.20 |
| F2 | | | | | 2.00 |
| Test | Condition | Standard/unit | | | |
| Ash content (average) | 850° C./0.5 h | % | 10.73 | 10.74 | 10.42 |
| (ro) | | | | | |
| MVR | 300° C.; 1.20 kg; 6 min | cm³/(10 min) | 18.9 | 19.1 | 14.7 |
| IMVR20′ | 300° C.; 1.20 kg; 19 min | cm³/(10 min) | 21.8 | 23.3 | 16 |
| ΔMVR/IMVR20′ | | | 2.9 | 4.2 | 1.3 |
| Reflectance | Hunter | ASTM E 1331 | | | |
| | UltraScanPRO, | with shine | | | |
| | Diffuse/8°; D65; 10° | | | | |
| Sample thickness (ro) | | mm | 2 | 2 | 2 |
| L* (ro) | | | 97.71 | 97.96 | 98.07 |
| a* (ro) | | | −0.51 | −0.53 | −0.55 |
| b* (ro) | | | 2.29 | 2.21 | 1.98 |
| Reflectance (ro) | | % | 94.19 | 94.83 | 95.08 |
| Yellowness index (ro) | | | 3.86 | 3.7 | 3.25 |
| 60° Shine (ro) | | | 102 | 101 | 100 |

The addition of only 0.20% by weight of epoxidized triacylglycerol leads to a significant improvement in reflectance (E-26 versus V-25). The addition of component F2, Paraloid EXL 2300, appears to provide another slight increase. At the same time, an improvement in yellowness index is observable.

TABLE 6

| | | | Example | | | | |
|---|---|---|---|---|---|---|---|
| | | | V-28 | E-29 | E-30 | E-31 | E-32 |
| | | | Component | | | | |
| | | | % by | % by | % by | % by | % by |
| | | | wt | wt | wt | wt | wt |
| A1 | | | 81.00 | 81.00 | 81.00 | 81.00 | 81.00 |
| A2 | | | 7.00 | 6.90 | 6.80 | 6.70 | 6.60 |
| B | | | 12.00 | 12.00 | 12.00 | 12.00 | 12.00 |
| C | | | | | | 0.20 | 0.20 |
| F3 | | | | 0.10 | 0.20 | 0.10 | 0.20 |
| Test | Condition | Standard/unit | | | | | |
| Ash content | Rapid ash | % | 11.93 | 11.99 | 12.02 | 11.66 | 12.04 |
| (average) | 850° C./0.5 h | | | | | | |
| MVR | 300° C.; 1.20 kg; 7 | cm³/(10 min) | 24.1 | 23 | 23.4 | 22.9 | 23.7 |
| | min | | | | | | |
| IMVR20′ | 300° C.; 1.20 kg; | cm³/(10 min) | 27.8 | 27.8 | 27.5 | 27.9 | 27.8 |
| | 20 min | | | | | | |
| Optical data | | | | | | | |
| Reflectance | Hunter | ASTM E 1331 | | | | | |
| | UltraScanPRO, | with shine | | | | | |
| | Diffuse/8°; D65; 10° | | | | | | |
| Sample thickness | | mm | 2 | 2 | 2 | 2 | 2 |
| L* | | | 98.14 | 98.23 | 98.3 | 98.39 | 98.43 |
| a* | | | −0.58 | −0.67 | −0.62 | −0.58 | −0.59 |
| b* | | | 2.31 | 2.35 | 2.37 | 2.26 | 2.24 |
| Reflectance | | % | 95.26 | 95.5 | 95.68 | 95.88 | 95.99 |
| Yellowness index | | | 3.84 | 3.83 | 3.91 | 3.73 | 3.68 |
| 60° Shine | | | 102 | 102 | 102 | 102 | 102 |

The same observations as before (Table 5) are made for addition of UV stabilizer.

TABLE 7

| | | | Example | | | | |
|---|---|---|---|---|---|---|---|
| | | | V-33 | V-34 | V-35 | E-36 | E-37 |
| | | | Component | | | | |
| | | | % by | % by | % by | % by | % by |
| | | | wt | wt | wt | wt | wt |
| A1 | | | 78.00 | 78.00 | 78.00 | 78.00 | 78.00 |
| A2 | | | 8.00 | 7.90 | 7.80 | 7.70 | 7.60 |
| B | | | 12.00 | 12.00 | 12.00 | 12.00 | 12.00 |
| C | | | | | | 0.20 | 0.20 |
| F2 | | | 2.00 | 2.00 | 2.00 | 2.00 | 2.00 |
| F3 | | | | 0.10 | 0.20 | 0.10 | 0.20 |
| Test | Condition | Standard/unit | | | | | |
| Ash content (average) | Rapid ash | % | 11.6 | 11.76 | 11.91 | 11.92 | 11.71 |
| | 850° C./0.5 h | | | | | | |
| MVR | 300° C.; 1.20 kg; 7 min | cm³/(10 min) | 15.6 | 16.8 | 16.8 | 16.6 | 16.8 |
| IMVR20' | 300° C.; 1.20 kg; | cm³/(10 min) | 17.2 | 18.0 | 18.4 | 18.7 | 19.2 |
| | 20 min | | | | | | |
| ΔMVR/IMVR20′ | | | 1.6 | 1.2 | 1.6 | 2.1 | 2.4 |
| Optical data | | | | | | | |
| Reflectance | Hunter | ASTM E 1331 | | | | | |
| | UltraScanPRO, | with shine | | | | | |
| | Diffuse/8°; D65; 10° | | | | | | |
| Sample thickness | | mm | 2 | 2 | 2 | 2 | 2 |
| L* | | | 98.5 | 98.55 | 98.55 | 98.59 | 98.58 |
| a* | | | −0.6 | −0.62 | −0.63 | −0.6 | -0.62 |
| b* | | | 2.11 | 2.16 | 2.18 | 2.1 | 2.11 |
| Reflectance | | % | 96.18 | 96.29 | 96.3 | 96.41 | 96.37 |
| Yellowness index | | | 3.43 | 3.51 | 3.54 | 3.42 | 3.44 |
| 60° Shine | | | 100 | 101 | 101 | 101 | 101 |

As expected, the addition of UV stabilizers has a slight adverse effect on yellowness index (V-33 versus V-34, V-35; intrinsic color of UV absorber). However, this effect is cancelled out again by addition of epoxidized triacylglycerol (E-36, E-37), with a slight improvement in reflectance occurring at the same time.

TABLE 8

| | | | Example | | | | | |
|---|---|---|---|---|---|---|---|---|
| | | | V-38 | E-39 | E-40 | E-41 | E-42 | E-43 |
| | | | Component | | | | | |
| | | | % by | % by | % by | % by | % by | % by |
| | | | wt | wt | wt | wt | wt | wt |
| A1 | | | 83.00 | 83.00 | 83.00 | 83.00 | 83.00 | 83.00 |
| A2 | | | 7.00 | 6.95 | 6.80 | 6.60 | 6.50 | 6.40 |
| B | | | 10.00 | 10.00 | 10.00 | 10.00 | 10.00 | 10.00 |
| C | | | | 0.05 | 0.20 | 0.40 | 0.50 | 0.60 |
| Test | Condition | Standard/unit | | | | | | |
| Ash content | 850° C./30 min | % | 9.52 | 9.48 | 9.69 | 9.7 | 9.54 | 9.62 |
| (average) | | | | | | | | |
| MVR | 300° C.; 1.20 kg; | cm³/[10 min] | 21.3 | 21.4 | 21.2 | 21.7 | 21.8 | 22.1 |
| | 7 min | | | | | | | |
| MVR | 300° C.; 1.20 kg; | cm³/[10 min] | 26.8 | 25.7 | 27.1 | 27.8 | 29.2 | 29.3 |
| | 20 min | | | | | | | |
| ΔMVR/IMVR20′ | | | 5.5 | 4.3 | 5.9 | 6.1 | 7.4 | 7.2 |
| Tg | | ° C. | 149.5 | 149.1 | 147.7 | 145.7 | 145.0 | 144.7 |
| Reflectance | Hunter | ASTM E 1331 | | | | | | |
| | UltraScanPRO, | with shine | | | | | | |
| | Diffuse/8°; D65; 10° | | | | | | | |
| Sample | | mm | 2 | 2 | 2 | 2 | 2 | 2 |
| thickness | | | | | | | | |
| L* | | | 97.77 | 98.04 | 98.24 | 98.3 | 98.38 | 98.4 |
| a* | | | −0.49 | −0.53 | −0.57 | −0.58 | −0.61 | −0.62 |
| b* | | | 2.38 | 2.31 | 2.23 | 2.15 | 2.26 | 2.23 |
| Reflectance | | % | 94.33 | 95.01 | 95.52 | 95.66 | 95.87 | 95.91 |
| Yellowness index | | | 4.05 | 3.87 | 3.71 | 3.54 | 3.71 | 3.64 |
| 60° Shine | | | 101 | 101 | 101 | 101 | 101 | 101 |

Increasing concentration of epoxidized triacylglycerol (E-39 to E-43) causes reflectance to increase compared to V-38, which contains no triacylglycerol. Yellowness index is also reduced. As expected, larger amounts of triacylglycerol result in a reduction in the glass transition temperature.

1. A thermoplastic composition, containing
A) aromatic polycarbonate,
B) titanium dioxide,
C) epoxidized triacylglycerol.

2. The thermoplastic composition as claimed in claim 1, containing
A) 59.99% by weight to 96.99% by weight of aromatic polycarbonate,
B) 3.0% by weight to 40.0% by weight of titanium dioxide,
C) 0.01% by weight to 5.0% by weight of epoxidized triacylglycerol,
wherein the reported amounts in % by weight are based on the total weight of the composition.

3. The thermoplastic composition as claimed in claim 1, containing
A) 69.99% by weight to 96.99% by weight of aromatic polycarbonate,
B) 3.0% by weight to 30.0% by weight of titanium dioxide,
C) 0.01% by weight to 2.0% by weight of epoxidized triacylglycerol,
D) 0.0% by weight to 1.0% by weight of heat stabilizer,
E) 0.0% by weight to 0.5% by weight of flame retardant selected from the group of alkali metal, alkaline earth metal or ammonium salts of aliphatic or aromatic sulfonic acid, sulfonamide or sulfonimide derivatives and combinations thereof and
F) 0.0% by weight to 10.0% by weight of further additives,
wherein the reported amounts in % by weight are based on the total weight of the composition.

4. The thermoplastic composition as claimed in claim 1, wherein the composition contains
A) 77.945% by weight to 96.945% by weight of aromatic polycarbonate,
B) 3.0% by weight to 22% by weight of titanium dioxide,
C) 0.05% by weight to 0.8% by weight of epoxidized triacylglycerol,
D) 0.005% by weight to 0.5% by weight of heat stabilizer,
E) 0.0% by weight to 0.5% by weight of flame retardant selected from the group of alkali metal, alkaline earth metal or ammonium salts of aliphatic or aromatic sulfonic acid, sulfonamide or sulfonimide derivatives and combinations thereof and
F) 0.0% by weight to 3.0% by weight of further additives,
wherein the reported amounts in % by weight are based on the total weight of the composition.

5. The thermoplastic composition as claimed in claim 1, wherein the thermoplastic composition consists of
A) 77.945% by weight to 96.945% by weight of aromatic polycarbonate,
B) 3.0% by weight to 22% by weight of titanium dioxide,
C) 0.05% by weight to 0.8% by weight of epoxidized triacylglycerol introduced into the composition in the form of epoxidized soybean oil,
D) 0.005% by weight to 0.5% by weight of heat stabilizer,
E) 0.0% by weight to 0.5% by weight of flame retardant selected from the group of alkali metal, alkaline earth metal or ammonium salts of aliphatic or aromatic sulfonic acid, sulfonamide or sulfonimide derivatives and combinations thereof and
F) 0.0% by weight to 3% by weight of further additives
and optionally blend partners.

6. The thermoplastic composition as claimed in claim 3, wherein the amount of component E is 0.05% by weight to 0.15% by weight.

7. The thermoplastic composition as claimed in claim 1, wherein the epoxidized triacylglycerol contains a mixture of triesters of glycerol with oleic acid, linoleic acid, linolenic acid, palmitic acid and/or stearic acid.

8. The thermoplastic composition as claimed in claim 1, wherein at least 90% by weight of the C═C double bonds from the carboxylic acid moieties of the triacylglycerols have been completely epoxidized.

9. The thermoplastic composition as claimed in claim 1, wherein component C is introduced into the thermoplastic composition through admixing of epoxidized soybean oil (CAS number 8013-07-8).

10. The thermoplastic composition as claimed in claim 3, wherein at least one anti-drip agent is present as a further additive of component F.

11. The thermoplastic composition as claimed in claim 10, wherein at least 0.1% by weight of anti-drip agents are present.

12. A molded part made of a thermoplastic composition as claimed in claim 1.

13. The molded part as claimed in claim 12, wherein the molded part is a reflector or part of a reflector for an LED illumination unit.

14. A method to improve reflectance of a titanium dioxide-containing polycarbonate composition comprising providing thereto an epoxidized triacylglycerol.

15. The method as claimed in claim 14, wherein the provision of the epoxidized triacylglycerol improves a yellowness index of the titanium dioxide-containing polycarbonate composition.

16. The method as claimed in claim 14, wherein the epoxidized triacylglycerol is in the form of epoxidized soybean oil.
